(19) United States
(12) Patent Application Publication
(10) Pub. No.: US 2001/0038373 A1
(43) Pub. Date: Nov. 8, 2001

(54) Liquid crystal display driving method and liquid crystal display device

(76) Inventors: Eiji Yamakawa, Sanda-Shi (JP); Kazuaki Okumura, Ikeda-Shi (JP); Naoki Masazumi, Kobe-Shi (JP)

Correspondence Address: SIDLEY AUSTIN BROWN & WOOD, 717 NORTH HARWOOD, SUITE 3400, DALLAS, TX, 75201, US

(21) Appl. No.: 09/817,397

(22) Filed: Mar. 26, 2001

(30) Foreign Application Priority Data
Mar. 30, 2000 (JP) 2000-095809

(51) Int. Cl. G09G 3/36

(52) U.S. Cl. 345/95

(57) ABSTRACT

A matrix driving method of a liquid crystal display which has liquid crystal which exhibits a cholesteric phase by applying voltages to the liquid crystal through a plurality of row electrodes and a plurality of column electrodes which cross each other at a right angle and face each other. In order to carry out writing on a target pixel which is in a planar state, a voltage V₁ is applied to a row electrode which defines the target pixel, and a divided voltage of −V₁ is applied to other peripheral row electrodes. Meanwhile, a voltage −V₁ is applied to a column electrode which defines the target pixel, and a divided voltage of V₁ is applied to other peripheral column electrodes. Thereby, only the target pixel is driven, and the reflectance of the part of the liquid crystal becomes lower. Thus, writing is carried out only on the target pixel.

This application is based on Japanese application No. 2000-95809 filed in Japan, the contents of which are hereby incorporated by reference.

### BACKGROUND OF THE INVENTION

1. Field of the Invention

The present invention relates to a liquid crystal display driving method and a liquid crystal display device, and more particularly to a matrix driving method of driving liquid crystal which exhibits a cholesteric phase by applying voltages through a plurality of row electrodes and a plurality of column electrodes which cross each other at a right angle and face each other, and a liquid crystal display device.

2. Description of Prior Art

In a liquid crystal display in which liquid crystal which exhibits a cholesteric phase is filled between two substrates, the alignment of liquid crystal molecules can be controlled to come to a planar state or a focal-conic state in accordance with voltages applied to electrodes which face each other with the liquid crystal in-between. Thus, the liquid crystal display displays an image thereon. While the liquid crystal in a planar state, the liquid crystal selectively reflects light of a wavelength λ=Pn (P: helical pitch of the liquid crystal molecules, n: the average refractive index of the liquid crystal). While the liquid crystal is in a focal-conic state, if the wavelength of light to be selectively reflected by the liquid crystal is in the infrared spectrum, the liquid crystal scatters light, and if the wavelength of light to be selectively reflected by the liquid crystal is shorter than the infrared spectrum, the liquid crystal transmits visible light. Accordingly, if the wavelength of light to be selectively reflected by the liquid crystal is set within the visible spectrum and if a light absorbing layer is provided in the side of the liquid crystal display opposite the observing side, the liquid crystal displays color of the selectively reflected light while being in a planar state and displays black while being in a focal-conic state. If the wavelength of light to be selectively reflected by the liquid crystal is set in the infrared spectrum and if a light absorbing layer is provided in the side of the liquid crystal display opposite the observing side, the liquid crystal, while being in a planar state, reflects infrared light and transmits visible light and accordingly displays black and, while being in a focal-conic state, scatters light and displays white. Further, by laminating three liquid crystal cells which selectively reflect light of red, light of green and light of blue respectively, a full-color display can be obtained.

Incidentally, liquid crystal which exhibits a cholesteric phase has a demerit that the writing speed is lower than that of nematic liquid crystal such as TN liquid crystal and STN liquid crystal. Accordingly, if a method in which image data are written line by line is adopted, the speed of writing an image is not sufficiently high.

In a well-known method of driving this kind of liquid crystal, the liquid crystal is reset to a homeotropic state before application of a selection voltage which determines the final state of the liquid crystal. In this method, however, every pixel at least on the row electrodes in an area to be subjected to writing is once reset to a homeotropic state, in which the liquid crystal displays no images thereon. Thus, during writing, there are times when some pixels display no images, and a flicker occurs.

Especially, when writing of new data is to be carried out in a rectangular area such as a check box and a softkey, all the pixels on the row electrodes which define the rectangular area must be subjected to writing. More specifically, the pixels within the rectangular area are subjected to writing of new data, while the other pixels on the row electrodes which define the rectangular area are subjected to writing of the same data. Thereby, a flicker occurs in the whole part defined by the row electrodes including the rectangular area. Also, the row electrodes are selected one by one, and it takes a long time for writing.

### SUMMARY OF THE INVENTION

An object of the present invention is to provide a liquid crystal display driving method and a liquid crystal display device which can inhibit a flicker on the screen during writing.

Another object of the present invention is to provide a liquid crystal display driving method and a liquid crystal display device which requires a short time for writing.

Further, another object of the present invention is to a liquid crystal display driving method and a liquid crystal display device which is capable of carrying out writing only on a desired pixel speedily.

In order to attain the objects, a first driving method reflecting one aspect of the present invention that is for driving a liquid crystal display which comprises a matrix of a plurality of pixels of liquid crystal exhibiting a cholesteric phase, the matrix being defined by a plurality of intersections of a plurality of row electrodes and a plurality of column electrodes which cross each other at a right angle, said method comprising the following first step and second step. That is, in the first step, a first voltage is applied to at least one of said row electrodes that corresponds to at least one target pixel, while a second voltage is applied to remaining ones of said row electrodes. The second voltage is set so as to be a divided voltage of the first voltage and to have a polarity opposing to that of the first voltage. In the second step, that is carried out simultaneously with the application of the first and second voltages in the first step, a third voltage is applied to at least one of said column electrodes that corresponds to the at least one target pixel, while a fourth voltage is applied to remaining ones of said column electrodes. The fourth voltage is set so as to be a divided voltage of the third voltage and to have a polarity opposing to that of the third voltage. By applying a composite voltage of the first and third voltages, the liquid crystal that corresponds to a target area consisting of the at least one target pixel is allowed to exhibit a transparent state thereof. On the other hand, by applying a composite voltage of the second and fourth voltages, the liquid crystal located at a non-target area consisting of peripheral pixels that are periphery of the at least one target pixel is allowed to maintain display states thereof. A first display device reflecting one aspect of the present invention is capable of carrying out the first driving method.

In the first driving method and in the first display device, writing is carried out only on a target pixel(s) while the same image is continuously displayed on the peripheral pixels. Accordingly, reset is not carried out on the entire displaying area except the target pixel(s), and a flicker is prevented. When changing the target pixel(s) into a focal-conic state, the target pixel(s) comes to a homeotropic state immediately by application of a reset pulse. To the observers, the homeotropic state and the focal-conic state are not distinguishable from each other, and apparent writing in this case is done more speedily. There may be a plurality of target pixels. If the target pixels form a rectangular area or if the target pixels are located on the same electrode, the target pixels can be subjected to writing at one time, and the time for writing becomes shorter. If an image is displayed on the target pixels, writing can be carried out in the same way.

A second driving method reflecting another aspect of the present invention that is for driving a liquid crystal display which comprises a plurality of liquid crystal cells laminated each other and each having a matrix of a plurality of pixels of liquid crystal exhibiting a cholesteric phase, the matrix being defined by a plurality of intersections of a plurality of row electrodes and a plurality of column electrodes which cross each other at a right angle, said method comprising the following first and second steps. That is, in the first step, a first voltage is applied to at least one of said row electrodes that corresponds to at least one target pixel and a second voltage to remaining ones of said row electrodes. The second voltage is set so as to be a divided voltage of the first voltage and to have a polarity opposing to that of the first voltage. In the second step, that is carried out simultaneously with the application of the first and second voltages in the first step, a third voltage is applied to at least one of said column electrodes that corresponds to the at least one target pixel and a fourth voltage to remaining ones of said column electrodes. The fourth voltage is set so as to be a divided voltage of the third voltage and to have a polarity opposing to that of the third voltage. By applying a composite voltage of the first and third voltages, the liquid crystal that corresponds to a target area consisting of the at least one target pixel is allowed to exhibit a transparent state thereof. On the other hand, by applying a composite voltage of the second and fourth voltages, the liquid crystal located at a non-target area consisting of peripheral pixels that are periphery of the at least one target pixel is allowed to maintain display states thereof. A second display device reflecting one aspect of the present invention is capable of carrying out the second driving method.

The second driving method and the second display device have the above-described advantages in connection with the first driving method and the first display device. Further, since a plurality of liquid crystal cells are laminated together, by superimposing images on the liquid crystal cells, various ways of displaying information are possible.

In the first and second driving methods and display devices, a plurality of pixels can be subjected to writing in the above-described way as long as the pixels are aligned in the extending direction of the column electrodes or in the extending direction of the row electrodes. Under the condition, the plurality of pixels may be sequentially disposed or may be scattered.

The first and second display devices may select a driving method from a plurality of driving methods. Also, the display devices may be so structured that the above-described driving method will be performed when a softkey is displayed.

### BRIEF DESCRIPTION OF THE DRAWINGS

These and other objects and features of the present invention will be apparent from the following description with reference to the accompanying drawings, in which:

FIG. 1 is a sectional view of an exemplary liquid crystal display which is suited to be driven by a driving method according to the present invention;

FIG. 2 is a graph which shows the relationship between the voltage applied to liquid crystal which exhibits a cholesteric phase and the reflectance of the liquid crystal;

FIG. 3 is an illustration which shows the fundamentals of a driving method according to the present invention;

FIGS. 4a and 4b are illustrations of a liquid crystal displaying area before and after writing by a driving method according to a first embodiment;

FIG. 5 is an illustration which shows the driving method according to the first embodiment;

FIGS. 6a and 6b are illustrations of a liquid crystal displaying area before and after writing by a driving method according to a second embodiment;

FIG. 7 is an illustration which shows the driving method according to the second embodiment;

FIGS. 8a and 8b are illustrations of a liquid crystal displaying area before and after writing by a driving method according to a third embodiment;

FIG. 9 is an illustration which shows the driving method according to the third embodiment;

FIGS. 10a and 10b are illustrations of a liquid crystal displaying area before and after writing by a driving method according to a fourth embodiment;

FIG. 11 is an illustration which shows the driving method according to the fourth embodiment;

FIGS. 12a and 12b are illustrations of a liquid crystal displaying area before and after writing by a driving method according to a fifth embodiment;

FIG. 13 is an illustration which shows the driving method according to the fifth embodiment;

FIGS. 14a and 14b are illustrations of a liquid crystal displaying area before and after writing by a driving method according to a sixth embodiment; and

FIG. 15 is an illustration which shows the driving method according to the sixth embodiment.

### DETAILED DESCRIPTION OF THE PREFERRED EMBODIMENTS

Preferred embodiments of a liquid crystal display driving method and a liquid crystal display device according to the present invention are described with reference to the drawings.

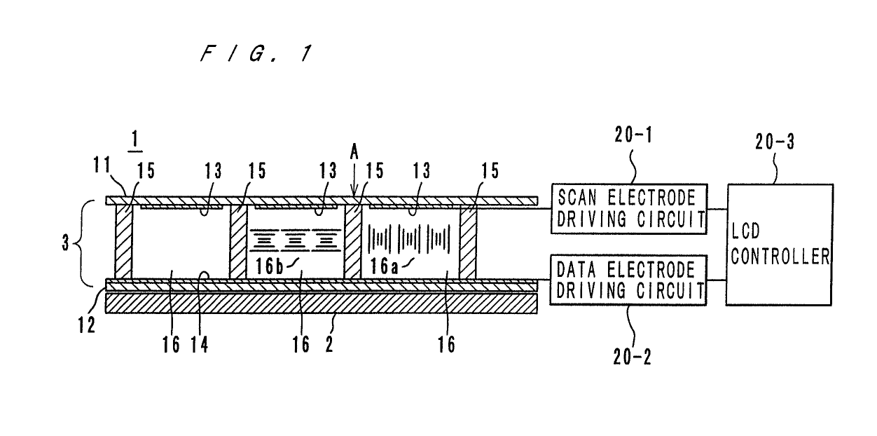

### Liquid Crystal Display; See FIG. 1

FIG. 1 shows an exemplary liquid crystal display which is suited to adopt a driving method according to the present invention. The liquid crystal display 1 has a liquid crystal cell 3 on a light absorbing layer 2 and selectively reflects light of a specified wavelength. Further, a liquid crystal display 5 shown by FIG. 15 that has three liquid crystal cells 3R, 3G and 3B for selectively reflecting light of red, light of green and light of blue respectively and that is capable of displaying a full-color image can adopt the driving method described below can be adapted for the liquid crystal display 5.

The liquid crystal cell 3 has, between transparent substrates 11 and 12 with transparent electrodes 13 and 14 thereon, resin columnar nodules 15, spacers (not shown) for regulating the thickness of the cell and liquid crystal 16. On the electrodes 13 and 14 which face each other, alignment controlling layers or insulating layers may be provided.

The liquid crystal 16 preferably exhibits a cholesteric phase at room temperature. Especially, chiral nematic liquid crystal which is produced by adding a chiral agent to nematic liquid crystal is suited.

A chiral agent is an additive which, when it is added to nematic liquid crystal, twists molecules of the nematic liquid crystal. When a chiral agent is added to nematic liquid crystal, the liquid crystal molecules form a helical structure with uniform twist intervals, and thereby, the liquid crystal exhibits a cholesteric phase.

However, the liquid crystal is not necessarily of this type. It is possible to structure the liquid crystal display layer to be a conventional polymer-dispersed type composite layer in which liquid crystal is dispersed in a three-dimensional polymer net or in which a three-dimensional polymer net is formed in liquid crystal.

The transparent electrodes 13 are strip-like electrodes which are arranged in parallel at fine intervals, and likewise, the transparent electrodes 14 are strip-like electrodes which are arranged in parallel at fine intervals. The intersections between the electrodes 13 and the electrodes 14 function as pixels. The transparent electrodes 13 and 14 are connected respectively to a scan electrode driving circuit 20-1 and to a data electrode driving circuit 20-2 and are supplied with voltages from these driving circuits 20-1 and 20-2. The driving circuits 20-1 and 20-2 are controlled by an LCD controller 20-3, and the control of the LCD controller 20-3 over the driving circuits 20-1 and 20-2 is in accordance with image signals. Thus, the LCD controller 20-3 controls the driving circuits 20-1 and 20-2 in accordance with the image signals, and the transparent electrodes 13 and 14 are supplied with pulse voltages respectively from the driving circuits 20-1 and 20-2 to carry out matrix driving of the liquid crystal 16.

In response to the voltages applied, the liquid crystal 16 switches between a transparent state (focal-conic state) to transmit visible light and a selective reflection state (planar state) to selectively reflect visible light. In FIG. 1, the pixel 16a is in a focal-conic state, and the pixel 16b is in a planar state.

Since the light absorbing layer 2 is located on the side opposite the observing side (indicated by arrow “A”), light which has passed through the liquid crystal 16 is wholly absorbed by the light absorbing layer 2. Accordingly, if the liquid crystal layer is entirely in a transparent state, the liquid crystal display 1 makes a display of black. As the light absorbing layer 2, for example, a black film can be used. Also, a black paint such as black ink may be coated on the lower surface of the liquid crystal cell 3.

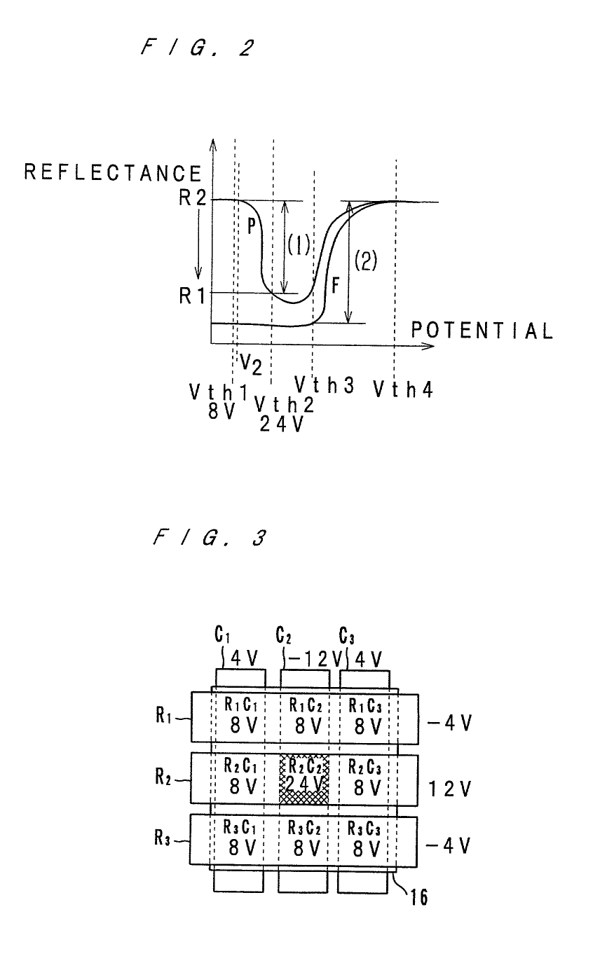

### Principle of Driving Method According to the Invention; See FIGS. 2 and 3

A driving method according to the present invention is to drive a liquid crystal display which has liquid crystal which exhibits a cholesteric phase. When writing is to be carried out in a rectangular area, a voltage with a polarity is applied to the electrodes within the rectangular area while a divided voltage with the opposite polarity is applied to the electrodes in the periphery of the rectangular area. Thereby, only the pixels in a planar state within the rectangular area are driven so as to have lower reflectance, and in this way, writing is carried out within the rectangular area.

FIG. 2 shows the relationship between a pulse voltage V with a specified pulse width which is applied to liquid crystal and the reflectance R of the liquid crystal. The curve P shows a case of applying a voltage V to liquid crystal in a planar state, and the curve F shows a case of applying a voltage V to liquid crystal in a focal-conic state. Possible ways of selecting the final state (transparent/reflection state) of each pixel are, mainly, using the area (1) shown in FIG. 2 (falling area of the curve P) and using the area (2) shown in FIG. 2 (rising area of the curve F).

First, the way of using the area (2) is described. When a threshold voltage is applied to liquid crystal which exhibits a cholesteric phase, the liquid crystal molecules are untwisted, and the liquid crystal comes to a transparent homeotropic state. The threshold voltage is referred to as Vth4. After applying the voltage Vth4 to the liquid crystal for a sufficiently long time, if the voltage is suddenly lowered under a first threshold voltage (for example, Vth1 shown in FIG. 2), the liquid crystal comes to a planar state. After the application of the voltage Vth4, if a voltage which is higher than a second threshold voltage (for example, Vth2 shown in FIG. 2) and lower than a third threshold voltage (for example, Vth3 shown in FIG. 3) is applied to the liquid crystal for a sufficiently long time, the liquid crystal comes to a focal-conic state. The liquid crystal can stay in a planar state or in a focal-conic state continuously after the application of the voltage is stopped. Further, after the application of the voltage Vth4, if a voltage between the third threshold voltage Vth3 and the fourth threshold voltage Vth4 is applied to the liquid crystal, the liquid crystal comes to an intermediate state between the planar state and the focal-conic state, and thus, it is possible to display intermediate tones.

It is possible to select each pixel to come to a desired state, for example, by the driving method disclosed by U.S. patent application Ser. No. 09/273,531 or the driving method disclosed by U.S. patent application identified by the attorney's docket No. 15162/03290. In the former driving method, all the pixels in the area which is to be subjected to writing are once reset to a focal-conic state, and each of the pixels is selected to finally come to a desired state. In the latter driving method, writing is carried out on each pixel by following a step of resetting the pixel to a homeotropic state, a step of applying a selection pulse in accordance with the desired final state of the pixel and a step of applying an evolution pulse to evolve the pixel to the selected state. In either method, while the row electrodes are selected one by one, pulse voltages are applied to the column electrodes to select the final states of the pixels on the selected row electrode.

Next, the way of using the area (1) shown in FIG. 2 is described. When the liquid crystal is initially in a planar state, application of a voltage lower than a threshold voltage Vth1 (i.e., the voltage right before the fall of the curve P) does not change the state of the liquid crystal. However, when a voltage higher than Vth1 is applied, the liquid crystal partly changes to a focal-conic state, and when a second threshold voltage Vth2 (i.e., the voltage around the end of the fall of the curve P) is applied, the liquid crystal almost entirely comes to a focal-conic state. When a voltage between Vth1 and Vth2 is applied, the liquid crystal comes to an intermediate state, and thus, it is possible to display intermediate tones.

When a voltage higher than V₂ (for example, Vth2) is applied to the liquid crystal, the liquid crystal comes to an intermediate state between the planar state and the focal-conic state, and the reflectance of the liquid crystal becomes lower. When a voltage lower than V₂ (for example, Vth1) is applied, the reflectance of the liquid crystal does not change. Therefore, by applying a voltage higher than V₂ only to the part of liquid crystal in a desired area, the reflectance of the liquid crystal only in the area changes, and writing is carried out only in the area.

FIG. 3 is an illustration of matrix driving of the liquid crystal. For simplification, nine pixels R₁C₁, through R₃C₃ which are defined by three row (scan) electrodes and three column (data) electrodes are shown. Writing only in the center pixel R₂C₂, which is shadowed in FIG. 3, is described. In the following description, specific voltage values are shown in parentheses; however, these values are merely examples.

The pixel R₂C₂ of the liquid crystal 16, which is to be subjected to writing (which is a target pixel), was set in a planar state beforehand. The scan electrode driving circuit 20-1 applies a voltage V₁ (12V) to the row electrode R₂ while applying a voltage −⅓V₁ (−4V) to the other row electrodes R₁ and R₃. Meanwhile, the data electrode driving circuit 20-2 applies a voltage −V₁ (−12V) to the column electrode C₂ while applying ⅓V₁ (4V) to the other column electrodes C₁ and C₃. Thereby, a voltage 2V₁ (24V) acts on the center pixel R₂C₂, and a voltage ⅔V₁ (8V) acts on the other peripheral pixels. Consequently, only the part of the liquid crystal corresponding to the pixel R₂C₂ is driven, and the reflectance of the part becomes low. Thus, writing only on the pixel R₂C₂ is carried out. During the writing, the image on the row electrode R₂ is not erased as a whole, and a flicker does not occur.

In the example above, the dividing rate is ⅓. The use of this rate facilitates equalization of voltages which act on the peripheral pixels around the pixel subjected to writing, which reduces crosstalk. Therefore, this rate is desirable. However, as long as the voltages which act on the peripheral pixels are not over a reference value, any other dividing rate can be used.

In the above, a case of writing only on one pixel has been described; however, the same driving method can be adopted to carry out writing in a rectangular area composed of a plurality of pixels.

If an alternating current is used, the voltages applied to the row electrodes and the column electrodes alter in polarity. In this case, the polarity alteration of the voltages applied to the row electrodes and the polarity alteration of the voltages applied to the column electrodes shall be timed to each other so that the voltage on the target pixel and the voltage on the peripheral pixels can have the above-described relationship.

For writing only in a rectangular area, the driving circuits 20-1 and 20-2 are also capable of carrying out a driving method using the area (2) of FIG. 2. The driving circuits 20-1 and 20-2 are preferably capable of carrying out other driving methods besides these methods, for example, a driving method in which the row electrodes are selected one by one for writing. In the latter method, the selection of the final state of each pixel may be carried out in any way, and for example, may be carried out by any method using the area (1) in FIG. 2.

### First Embodiment; See FIGS. 4a, 4b and 5

The first embodiment is a case of carrying out writing in one rectangular area in a liquid crystal displaying area.

In FIG. 4a, X₁ indicates the whole displaying area before writing, and Y1 indicates a rectangular area in a planar state before writing. The above-described driving method illustrated by FIG. 3 is carried out for writing in the rectangular area Y1. In FIG. 4b, X₂ indicates the whole displaying area after the writing, and Y2 indicates the rectangular area after the writing. In the first embodiment, the rectangular area is a check box for “check 1”.

In the rest of the liquid crystal display area other than the rectangular area Y₁, any image can be displayed. In the first embodiment, a single color (for example, white) is displayed except the letters describing the check box. The display of the letters and the single color can be carried out by a method using the area (1) shown in FIG. 2 or any other method. This is the same as in the following embodiments.

FIG. 5 shows application of voltages to the electrodes to carry out the writing shown by FIGS. 4a and 4b. The scan electrode driving circuit 20-1 applies the voltage V₁ (12V), which is necessary for writing, to a row electrode voltage input terminal 21a which is shown in black in FIG. 5 and applies the voltage −⅓V₁ (−4V) to the other row electrode voltage input terminals 21b. Meanwhile, the data electrode driving circuit 20-2 applies the voltage −V₁ (−12V), which is necessary for writing, to a column electrode voltage input terminal 22a which is shown in black in FIG. 5 and applies the voltage ⅓V₁ (4V) to the other column electrode voltage input terminals 22b.

By the application of the voltages, the voltage 2V₁ (24V) acts on the rectangular area Y₁, and the voltage ⅔V₁ (8V) acts on the rest of the displaying area. Thereby, only the part of the liquid crystal in the rectangular area Y1 supplied with the voltage 2V₁ (24V) is driven, and the reflectance in the area Y1 becomes lower. Thus, writing in the rectangular area Y₁ (checking of the box) is carried out.

Since the pulse voltage V₁ for writing is applied to a plurality of row electrodes including the row electrodes which define the check box simultaneously, high-speed writing is possible. Further, in the other area, the voltage is kept in ⅓V₁, and the letters by the side of the check box can be displayed continuously.

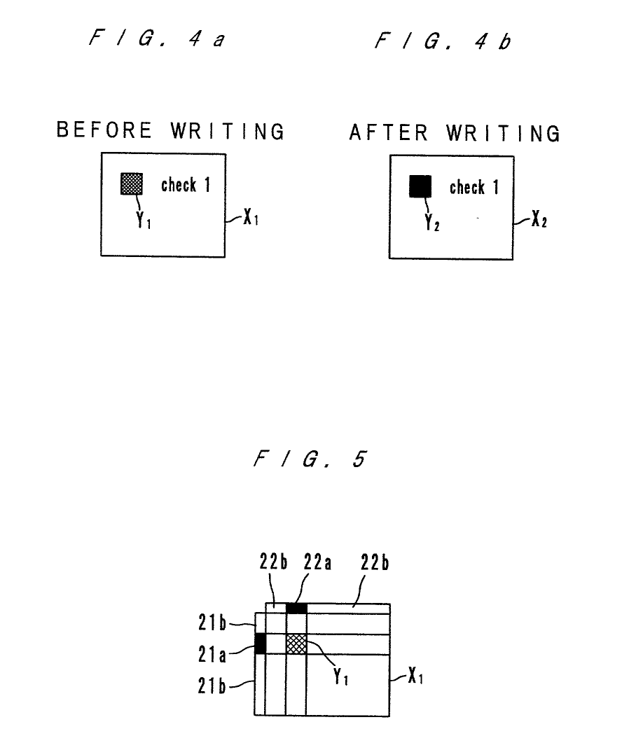

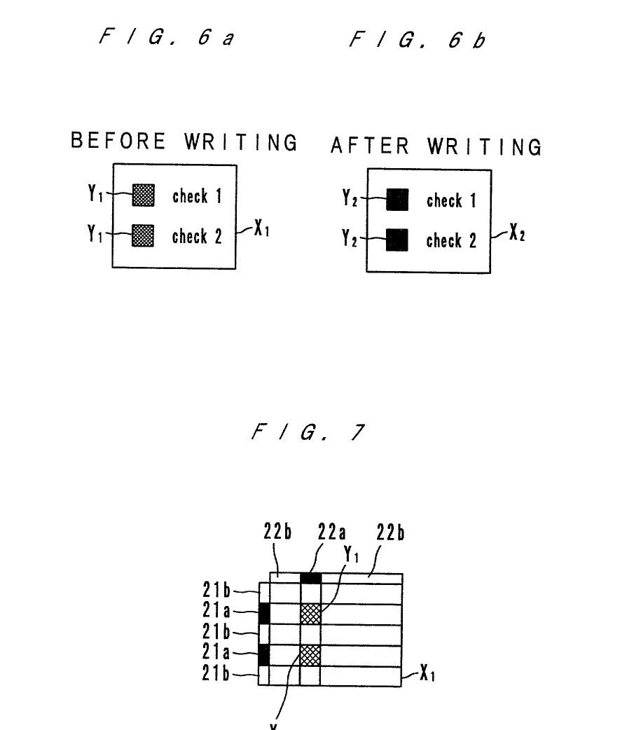

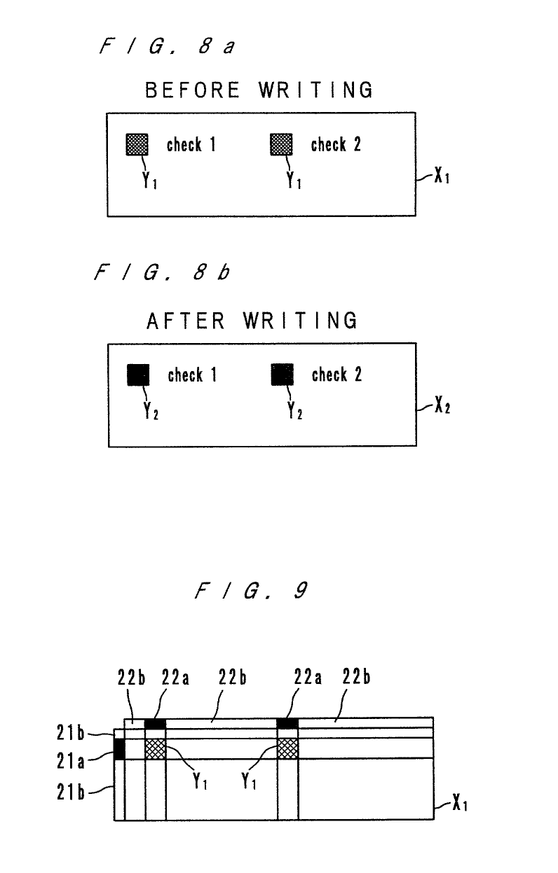

Second Embodiment; See FIGS. 6a, 6b and 7

The second embodiment is a case of writing in rectangular areas which are aligned in the extending direction of the column electrodes in a liquid crystal displaying area. Further, in the second embodiment, the lengths of the rectangular areas in the extending direction of the row electrodes are equal to each other.

In FIG. 6a, X₁ indicates the whole displaying area before writing, and Y₁ indicates the rectangular areas in a planar state before writing. The above-described driving method illustrated by FIG. 3 is carried out for writing in the rectangular areas Y₁. In FIG. 6b, X₂ indicates the whole displaying area after the writing, and Y2 indicates the rectangular areas after the writing. In the second embodiment, the rectangular areas are check boxes for “check 1” and “check 2”.

FIG. 7 shows application of voltages to the electrodes to carry out the writing shown by FIGS. 6a and 6b. The scan electrode driving circuit 20-1 applies the voltage V₁ (12V), which is necessary for writing, to row electrode voltage input terminals 21a which are shown in black in FIG. 7 and applies the voltage −⅓V₁ (−4V) to the other row electrode voltage input terminals 21b. Meanwhile, the data electrode driving circuit 20-2 applies the voltage −V₁ (−12V), which is necessary for writing, to a column electrode voltage input terminal 22a which is shown in black in FIG. 7 and applies the voltage ⅓V₁ (4V) to the other column electrode voltage input terminals 22b.

By the application of the voltages, the voltage 2V₁ (24V) acts on the rectangular areas Y₁, and the voltage ⅔V₁ (8V) acts on the rest of the displaying area. Thereby, only the parts of the liquid crystal in the rectangular areas Y₁ supplied with the voltage 2V₁ (24V) are driven, and the reflectance in the areas Y₁ becomes lower. Thus, writing in the rectangular areas Y₁ (checking of the boxes) is carried out.

In this method, it is not necessary to select the row electrodes including the rectangular area Y₁ and those including the rectangular area Y₂ serially, and the check boxes are subjected to writing at one time. Therefore, high-speed writing is possible. This method is convenient in a case of marking any one of a plurality of check boxes and simultaneously marking other associating check boxes.

Third Embodiment; See FIGS. 8a, 8b and 9 The third embodiment is a case of writing in rectangular areas which are aligned in the extending direction of the row electrodes in a liquid crystal displaying area. Further, in the third embodiment, the lengths of the rectangular areas in the extending direction of the column electrodes are equal to each other.

In FIG. 8a, X₁ indicates the whole displaying area before writing, and Y₁ indicates the rectangular areas in a planar state before writing. The above-described driving method illustrated by FIG. 3 is carried out for writing in the rectangular areas Y₁. In FIG. 8b, X₂ indicates the whole displaying area after the writing, and Y₂ indicates the rectangular areas after the writing. In the third embodiment, the rectangular areas are check boxes for “check 1” and “check 2”.

FIG. 9 shows application of voltages to the electrodes to carry out the writing shown by FIGS. 8a and 8b. The scan electrode driving circuit 20-1 applies the voltage V₁ (12V), which is necessary for writing, to a row electrode voltage input terminal 21a which is shown in black in FIG. 9 and applies the voltage −⅓V₁ (−4V) to the other row electrode voltage input terminals 21b. Meanwhile, the data electrode driving circuit 20-2 applies the voltage −V₁ (−12V), which is necessary for writing, to column electrode voltage input terminals 22a which are shown in black in FIG. 9 and applies the voltage ⅓V₁ (4V) to the other column electrode voltage input terminals 22b.

By the application of the voltages, the voltage 2V₁ (24V) acts on the rectangular areas Y₁, and the voltage ⅔V₁ (8V) acts on the rest of the displaying area. Thereby, only the parts of the liquid crystal in the rectangular areas Y₁ supplied with the voltage 2V₁ (24V) are driven, and the reflectance in the areas Y₁ becomes lower. Thus, writing in the rectangular areas Y₁ (checking of the boxes) is carried out.

Off course, in this case, the letters by the sides of the check boxes are displayed continuously. This method is convenient in a case of marking any one of a plurality of check boxes which are aligned in the extending direction of the row electrodes and simultaneously marking other associating check boxes.

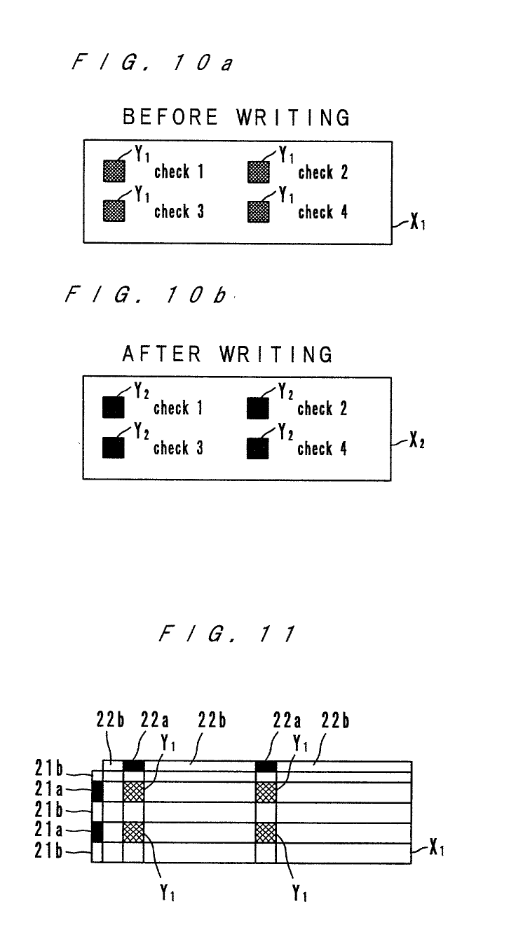

Fourth Embodiment; See FIGS. 10a, 10b and 11 The fourth embodiment is a case of writing four rectangular areas which are aligned in two rows in the horizontal direction and aligned in two columns in the vertical direction. With respect to the rectangular areas which are aligned in the vertical direction, the lengths in the horizontal direction are equal to each other, and with respect to the rectangular areas which are aligned in the horizontal direction, the lengths in the vertical direction are equal to each other.

In FIG. 10a, X₁ indicates the whole liquid crystal displaying area before writing, and Y₁ indicates the four rectangular areas in a planar state before writing. The above-described driving method illustrated by FIG. 3 is carried out for writing in the rectangular areas Y₁. In FIG. 8b, X₂ indicates the whole displaying area after the writing, and Y₂ indicates the rectangular areas after the writing. In the fourth embodiment, the rectangular areas are check boxes for “check 1” through “check 4”.

FIG. 11 shows application of voltages to the electrodes to carry out the writing shown by FIGS. 10a and 10b. The scan electrode driving circuit 20-1 applies the voltage V₁ (12V), which is necessary for writing, to row electrode voltage input terminals 21a which are shown in black in FIG. 11 and applies the voltage −⅓V₁ (−4V) to the other row electrode voltage input terminals 21b. Meanwhile, the data electrode driving circuit 20-2 applies the voltage −V₁ (−12V), which is necessary for writing, to column electrode voltage input terminals 22a which are shown in black in FIG. 11 and applies the voltage ⅓V₁ (4V) to the other column electrode voltage input terminals 22b.

By the application of the voltages, the voltage 2V₁ (24V) acts on the rectangular areas Y₁, and the voltage ⅔V₁ (8V) acts on the rest of the displaying area. Thereby, only the parts of the liquid crystal in the rectangular areas Y₁ supplied with the voltage 2V₁ (24V) are driven, and the reflectance in the areas Y₁ becomes lower. Thus, writing in the rectangular areas Y₁ (checking of the boxes) is carried out.

This method is convenient in a case of checking boxes which are located at four corners simultaneously. Off course, this method can be adopted to check boxes which are aligned in three or more columns and/or in three or more rows, for example, to check 3×2 boxes, 2×3 boxes or 3×3 boxes.

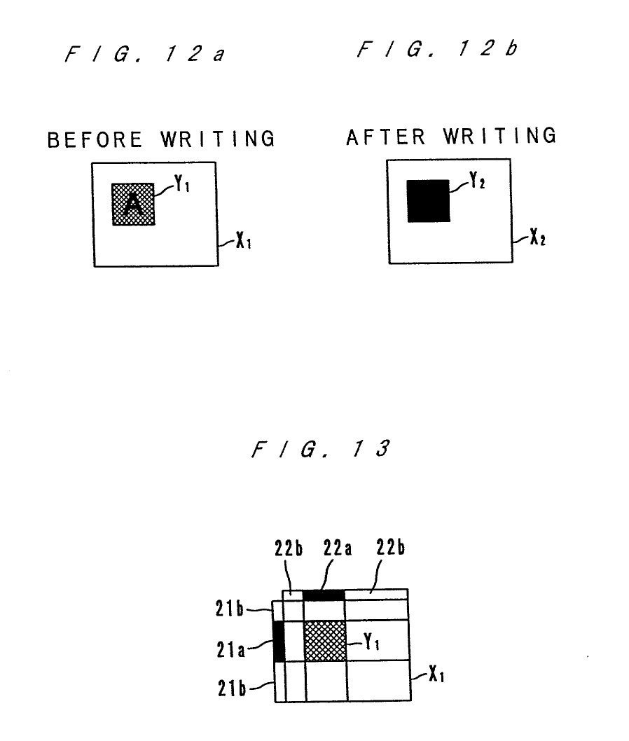

### Fifth Embodiment; See FIGS. 12a, 12b and 13

The fifth embodiment is a case of writing in a rectangular area in which a letter “A” in a focal-conic state is displayed on the background in a planar state.

In FIG. 12a, X₁ indicates the whole liquid crystal displaying area before writing, and Y₁ indicates the rectangular area before writing. In the rectangular area Y₁, a letter “A” in a focal-conic state is displayed on the background in a planar state. The above-described driving method illustrated by FIG. 3 is carried out for writing in the rectangular area Y₁. In FIG. 12b, X₂ indicates the whole displaying area after the writing, and Y₂ indicates the rectangular area after the writing. By the writing, the letter “A” is erased.

FIG. 13 shows application of voltages to the electrodes to carry out the writing shown by FIGS. 12a and 12b. The scan electrode driving circuit 20-1 applies the voltage V₁ (12V), which is necessary for writing, to a row electrode voltage input terminal 21a which is shown in black in FIG. 13 and applies the voltage −⅓V₁ (−4V) to the other row electrode voltage input terminals 21b. Meanwhile, the data electrode driving circuit 20-2 applies the voltage −V₁ (−12V), which is necessary for writing, to a column electrode voltage input terminal 22a which is shown in black in FIG. 13 and applies the voltage ⅓V₁ (4V) to the other column electrode voltage input terminals 22b.

By the application of the voltages, the voltage 2V₁ (24V) acts on the rectangular area Y₁, and the voltage ⅔V₁ (8V) acts on the other area. Thereby, only the part of the liquid crystal in the rectangular area Y₁ supplied with the voltage 2V₁ (24V) is driven, and the reflectance in the area Y₁ becomes lower. Thus, writing (erasing of the letter) in the rectangular area Y₁ is carried out.

In this method, the image displayed in the rectangular area is erased, while the color of the rectangular area changes rapidly. For example, if this method is adopted for writing in a softkey, the display in the softkey can be changed in accordance with operation of the softkey.

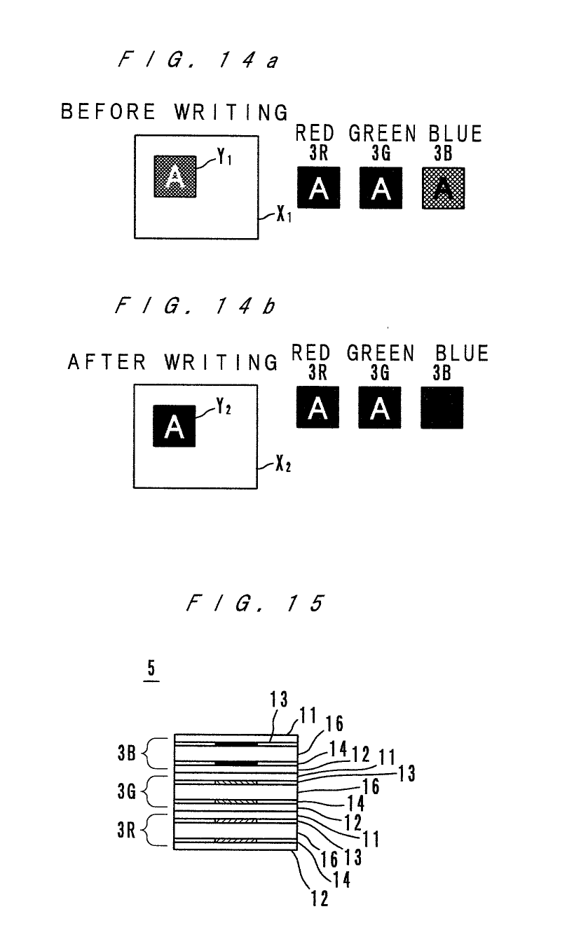

Sixth Embodiment; See FIGS. 14a, 14b and 15 The sixth embodiment is to be adopted in a liquid crystal display 5 which has liquid crystal display layers 3R, 3G and 3B which selectively reflect light of red, light of green and light of blue respectively. The sixth embodiment is to carry out reversal display of the background of a letter “A” displayed in a rectangular area. In at least one of the display layers, a letter “A” in a focal-conic state is displayed on the background in a planar state, and in each of the other display layers, a letter “A” in a planar state is displayed on the background in a focal-conic state.

In FIG. 14a, X₁ indicates the whole liquid crystal displaying area before reversal display, and Y₁ indicates the rectangular area before reversal display. At this time, in the blue display area 3B, a letter “A” in a focal-conic state is displayed in the rectangular area set in a planar state. In each of the other display layers 3R and 3G, a letter “A” in a planar state is displayed in the rectangular area set in a focal-conic state. Accordingly, in the rectangular area Y₁, a letter “A” of yellow is displayed on the background of blue.

The above-described driving method illustrated by FIG. 3 is carried out for writing in the rectangular area Y₁. In FIG. 14b, X₂ indicates the whole displaying area after the writing, and Y₂ indicates the rectangular area after the writing. By the writing, the background in the rectangular area Y₂ is changed to black.

In the sixth embodiment, only the blue display layer 3B is driven, and voltages are applied to the row electrodes and the column electrodes in the same way described in the fifth embodiment. In FIG. 15, the electrodes to which the voltages ±V₁ (±12V) are applied are shown in black.

By the application of the voltages, in the blue display layer 3B, the voltage 2V₁ (24V) acts on the rectangular area, and the voltage ⅔V₁ (8V) acts on the rest of the displaying area. The other display layers 3R and 3G are not driven. Consequently, only the part of the liquid crystal in the rectangular area of the blue display layer 3B which is supplied with the voltage 2V₁ (24V) is driven, and the reflectance becomes lower. Thus, reversal display from blue to black is carried out.

In this way, the color of the background in the rectangular area can be changed without changing the displayed information. This permits display which is easily recognizable to the operator. Repetitive performance of this method is effective to check and uncheck a box alternately.

### Other Embodiments

In the fifth an sixth embodiments, a case of erasing a letter “A” in a rectangular area and a case of carrying out reversal display of the background in the rectangular area are described. The information displayed in the rectangular area may be a letter, a mark, a drawing, etc.

With respect to the method described in the sixth embodiment, two or three of the three display layers may be driven to change the color of the background in the rectangular area. By keeping one of the display layers in a selective reflection state while keeping the other display layers in a transparent state, the background can be changed to a color other than black.

Although the present invention has been described in connection with the preferred embodiments above, it is to be noted that various changes and modifications are possible to those who are skilled in the art. Such changes and modifications are to be understood as being within the scope of the invention.

What is claimed is:

1. A method of driving a liquid crystal display which comprises a matrix of a plurality of pixels of liquid crystal exhibiting a cholesteric phase, the matrix being defined by a plurality of intersections of a plurality of row electrodes and a plurality of column electrodes which cross each other at a right angle, said method comprising:
a first step of applying a first voltage to at least one of said row electrodes that corresponds to at least one target pixel and a second voltage to remaining ones of said row electrodes, the second voltage being a divided voltage of the first voltage and having a polarity opposing to that of the first voltage; and
a second step of applying, simultaneously with the application of the first and second voltages in the first step, a third voltage to at least one of said column electrodes that corresponds to the at least one target pixel and a fourth voltage to remaining ones of said column electrodes, the fourth voltage being a divided voltage of the third voltage and having a polarity opposing to that of the third voltage,
wherein an application of a composite voltage of the first and third voltages allows the liquid crystal that corresponds to a target area consisting of the at least one target pixel to exhibit a transparent state thereof, and an application of a composite voltage of the second and fourth voltages allows the liquid crystal located at a non-target area consisting of peripheral pixels that are periphery of the at least one target pixel to maintain display states thereof.

2. A driving method according to claim 1, wherein the target area consists of a plurality of target pixels.

3. A driving method according to claim 2, wherein an image is previously displayed in the target area before the first step.

4. A driving method according to claim 2, wherein the target area forms a rectangular shape corresponding to a plurality of row electrodes and a plurality of column electrodes.

5. A driving method according to claim 2, wherein the target area forms a rectangular shape corresponding to only one of said plurality of row electrodes or only one of said column electrodes.

6. A driving method according to claim 1, wherein a ratio between an amplitude of the first voltage and an amplitude of the second voltage is 3:1, and wherein a ratio between an amplitude of the third voltage and an amplitude of the fourth voltage is 3:1.

7. A driving method of driving a liquid crystal display which comprises a plurality of liquid crystal cells laminated each other and each having a matrix of a plurality of pixels of liquid crystal exhibiting a cholesteric phase, the matrix being defined by a plurality of intersections of a plurality of row electrodes and a plurality of column electrodes which cross each other at a right angle, said method comprising:
a first step of applying a first voltage to at least one of said row electrodes that corresponds to at least one target pixel and a second voltage to remaining ones of said row electrodes, the second voltage being a divided voltage of the first voltage and having a polarity opposing to that of the first voltage; and
a second step of applying, simultaneously with the application of the first and second voltages in the first step, a third voltage to at least one of said column electrodes that corresponds to the at least one target pixel and a fourth voltage to remaining ones of said column electrodes, the fourth voltage being a divided voltage of the third voltage and having a polarity opposing to that of the third voltage, wherein an application of a composite voltage of the first and third voltages allows the liquid crystal that corresponds to a target area consisting of the at least one target pixel to exhibit a transparent state thereof, and an application of a composite voltage of the second and fourth voltages allows the liquid crystal located at a non-target area consisting of peripheral pixels that are periphery of the at least one target pixel to maintain display states thereof.

8. A driving method according to claim 7, wherein the target area consists of a plurality of target pixels.

9. A driving method according to claim 8, wherein an image is previously displayed in the target area before the first step.

10. A driving method according to claim 8, wherein the target area forms a rectangular shape corresponding to a plurality of row electrodes and a plurality of column electrodes.

11. A driving method according to claim 8, wherein the target area forms a rectangular shape corresponding to only one of said plurality of row electrodes or only one of said column electrodes.

12. A driving method according to claim 7, wherein a ratio between an amplitude of the first voltage and an amplitude of the second voltage is 3:1, and wherein a ratio between an amplitude of the third voltage and an amplitude of the fourth voltage is 3:1.

13. A liquid crystal display device comprising:
liquid crystal exhibiting a cholesteric phase;
a plurality of row electrodes and a plurality of column electrodes which cross each other at a right angle and faces each other with sandwiching said liquid crystal in between, said row electrodes and said column electrodes forming intersections thereof defining a matrix of a plurality of pixels of the liquid crystal; and
a driver connected with said row electrodes and said column electrodes, said driver being adapted to carry out a first driving method comprising:
a first step of applying a first voltage to at least one of said row electrodes that corresponds to at least one target pixel and a second voltage to remaining ones of said row electrodes, the second voltage being a divided voltage of the first voltage and having a polarity opposing to that of the first voltage; and
a second step of applying, simultaneously with the application of the first and second voltages in the first step, a third voltage to at least one of said column electrodes that corresponds to the at least one target pixel and a fourth voltage to remaining ones of said column electrodes, the fourth voltage being a divided voltage of the third voltage and having a polarity opposing to that of the third voltage,
wherein an application of a composite voltage of the first and third voltages allows the liquid crystal that corresponds to a target area consisting of the at least one target pixel to exhibit a transparent state thereof, and an application of a composite voltage of the second and fourth voltages allows the liquid crystal located at a non-target area consisting of peripheral pixels that are periphery of the at least one target pixel to maintain display states thereof.

14. A liquid crystal display device according to claim 13, wherein the driver is adapted to carry out a second driving method that is different from the first driving method.

15. A liquid crystal display device according to claim 14, wherein the driver selectively carries out one of the first and second driving method.

16. A liquid crystal display device according to claim 13, wherein the target area consists of a plurality of target pixels.

17. A liquid crystal display device according to claim 16, wherein an image is previously displayed in the target area before the first step.

18. A liquid crystal display device according to claim 16, wherein the target area forms a rectangular shape corresponding to a plurality of row electrodes and a plurality of column electrodes.

19. A liquid crystal display device according to claim 16, wherein the target area forms a rectangular shape corresponding to only one of said plurality of row electrodes or only one of said column electrodes.

20. A liquid crystal display device according to claim 13, wherein a ratio between an amplitude of the first voltage and an amplitude of the second voltage is 3:1, and wherein a ratio between an amplitude of the third voltage and an amplitude of the fourth voltage is 3:1.

21. A liquid crystal display device according to claim 13, wherein said liquid crystal display device comprises a plurality of liquid crystal cells laminated each other and each comprising: the liquid crystal; the row electrodes and the column electrodes; and the driver.
